(19) United States
(12) Patent Application Publication
(10) Pub. No.: US 2023/0363454 A1
(43) Pub. Date: Nov. 16, 2023

(54) ELECTRONIC SMOKING SIMULATION DEVICE WITH RESISTANCE RECORDING AND REPLAY

(71) Applicant: Evolv, LLC, Ashtabula, OH (US)

(72) Inventors: James Bellinger, Akron, OH (US); John Bellinger Decker, Pittsburgh, PA (US)

(21) Appl. No.: 18/030,490

(22) PCT Filed: Jan. 25, 2019
(86) PCT No.: PCT/US19/15303

§ 371 Date: Apr. 5, 2023

Related U.S. Application Data
(60) Provisional application No. 62/622,148, filed on Jan. 26, 2018.

(51) Int. Cl. A24F 40/46; A24F 40/57; A24F 40/60; A24F 40/44; A24F 40/10

(52) U.S. Cl. CPC A24F 40/46; A24F 40/57; A24F 40/60; A24F 40/44; A24F 40/10

(57) ABSTRACT

An electronic vaporizer with heating element electrical resistance recording and replay functionality, where the device makes a real-time recording of the electrical resistance of the heating element during operation, and the user is able to select a desirable puff from those recorded for replay. On subsequent puffs, the device control system modifies power delivery to achieve a similar profile of electrical resistance over time. Additionally, an electronic circuit implementing the same functionality.

### CROSS-REFERENCE TO RELATED APPLICATIONS

This application claims the benefit of U.S. Provisional Application No. 62/622,148, filed Jan. 26, 2018, which is incorporated in its entirety herein by reference.

### BACKGROUND OF THE INVENTION

### 1. Field of the Invention

This application relates generally to a method and apparatus for controlling an electronic vaporizer and, more specifically, to a method and apparatus that records resistance parameters during a desirable puff and controls operation of a heating element to reproduce the desirable puff.

### 2. Description of Related Art

Electronic vaporizers control operation of a heating element to produce a vapor that allows users to simulate smoking or inhaling a substance (called an “e-liquid” or “liquid” herein). It is desirable to avoid overheating of the e-liquid to prevent users from inhaling the burnt e-liquid. At ordinary heating element temperatures (typically around 400-480° Fahrenheit), heating causes the e-liquid to boil, and the device user inhales it (called taking a “puff”). As temperatures rise, however, e-liquids thermally decompose into other substances that may have an unpleasant taste or may otherwise be undesirable.

### BRIEF SUMMARY OF THE INVENTION

Accordingly, there is a need in the art to control operation of a heating element of an electronic vaporizer to reliably reproduce a pleasant puff and limit overheating of the e-liquid as a result of changes to the heating element's properties over time. The present electronic vaporizer, control system and control method control the output power supplied to the heating element based on a recorded profile included a sensed resistance values of the heating element. The resistance values of the heating element included in the recorded profile can be stored in a computer memory in response to receiving user input submitted via a user interface. The user input is indicative that the user enjoyed a previous puff, and desires to reproduce that experience during a subsequent puff in the future. Based on the recorded profile, operation of the heating element can be controlled during the subsequent puff to reproduce one or more resistance values of the heating element measured at times during the previous puff.

One or more characteristics, such as the temperature of the heating element, the formation of an oxide coating on the heating element, a change of the heating element, etc., causes the heating element's resistance to change. Rather than attempting to maintain a constant output power supplied to the heating element for different puffs, the output power supplied to the heating element during a subsequent puff is to be varied to reproduce the resistance values in the recorded profile for the previous puff. It is believed that attempting to reproduce a recorded profile for a previous puff will produce a similar simulated-smoking experience to the user during the subsequent puff.

According to one aspect, the subject application involves an electronic vaporizer for elevating a temperature of a heating element having an electrical resistance that changes with changes in temperature. The electronic vaporizer can include a control system that supplies an output power to the heating element to elevate a temperature of a medium to be aerosolized, and converts a portion of the medium into a vapor to be inhaled by a user. An electrical connector establishes a conductive pathway between the heating element and the control system. A resistance measuring component included as part of the control system determines the electrical resistance of the heating element at one or more times during a first puff and generates a recorded profile for the first puff. The recorded profile includes data indicative of the electrical resistance of the heating element system during the first puff. A non-transitory computer-readable medium stores the recorded profile for the first puff. An output control component accesses the recorded profile and adjusts the output power supplied to the heating element during a subsequent puff based, at least in part, on the recorded profile, to cause the electrical resistance of the heating element during the subsequent puff to approach the electrical resistance of the heating element during the first puff.

According to another aspect, the recorded profile is stored by the non-transitory computer-readable medium in response to entry of a save command a user interface.

According to another aspect, embodiments of the electronic vaporizer also include a tank comprising the heating element in thermal communication with a wicking material, wherein the tank comprises a portion of a releasable connector that cooperates with the electrical connector to establish the conductive pathway between the heating element and the control system.

According to another aspect, embodiments of the output control component control the output power to cause the heating element to exhibit resistances during the subsequent puff at times when the heating element exhibited similar resistances during the first puff, to mimic operation of the heating element during the first puff from a resistance standpoint.

According to another aspect, embodiments of the recorded profile for the first puff further include a value related to the output power supplied to the heating element during the first puff.

According to another aspect, embodiments of the control system limit the maximum output power supplied to the heating element to a level that is functionally dependent on the power level for the first puff stored in the recorded profile.

According to another aspect, embodiments of the control system limit the maximum output power supplied to the heating element to a power level that is equal to or greater than the power level stored in the recorded profile.

According to another aspect, the maximum power level of the output power supplied to the heating element during the subsequent puff is limited by the control system to no greater than 200% of an average recorded power level of the output power supplied to the heating element during the first puff.

According to another aspect, the maximum power level of the output power supplied to the heating element during the subsequent puff is limited by the control system to no greater than 200% of an instantaneous power level of the output power supplied to the heating element during the first puff.

According to another aspect, embodiments of the resistance measurement component determine the electrical resistance of the heating element and generates the recorded profile for a plurality of puffs, and the control system is operatively connected to a user interface that comprises an input device. The input device, in response to being manipulated following select puffs included among the plurality of puffs that the user desires to replay, causes a recorded profile for the select puffs to be generated and stored in the non-transitory computer-readable medium.

According to another aspect, if a duration of the subsequent puff is longer than a duration of the first puff, a resistance value based on a value stored in the recorded profile for the first puff is maintained by the control system until the subsequent puff is completed.

According to another aspect, the control system's reactivity to a resistance change or error decreases with an increase to the range of resistances included in or computed from the recorded profile.

According to another aspect, embodiments of the electronic vaporizer also include a tank that is fixedly installed as part of the vaporizer, and the heating element is hardwired with a fixed connection to the electrical connector.

According to another aspect, the electrical resistance determined by the resistance measuring component comprises a resistance contribution by the heating element, and a resistance contribution by an electrical path utilized to supply the output power to the heating element.

According to another aspect, embodiments of the resistance measuring component determines the electrical resistance of the heating element independently of an actual, measured temperature of the heating element.

According to another aspect, embodiments of the output control component adjust the output power supplied to the heating element during the subsequent puff by, one or more of: adjusting a pulse-width of a voltage of the output power, or using DC-DC conversion.

According to another aspect, embodiments of the control system are configured to automatically generate, store and replay the recorded profile without receiving a manually-input instruction from the user.

According to another aspect, the subject application involves a control circuit for an electronic vaporizer. The control circuit adjusts an output power supplied to a heating element in thermal communication with a media to be aerosolized, to elevate a temperature of the media and convert a portion of the media into a vapor to be inhaled by a user during a first puff. The control circuit includes a resistance measurement circuit that determines electrical a resistance of a portion of an electric path including the heating element at different times during the first puff, and generates a recorded profile for the first puff. The recorded profile comprising the determined electrical resistances for the first puff and/or changes of the electrical resistance that occurred at the different times during the first puff. A non-transitory computer-readable medium stores the recorded profile for the first puff, and a power output circuit accesses the recorded profile and adjusts the output power supplied to the heating element to cause the resistance of the heating element during a subsequent puff to follow or target the recorded profile for the first puff.

According to another aspect, embodiments of the recorded profile include a value related to the output power supplied to the heating element during the first puff.

According to another aspect, embodiments of the power output circuit limit the maximum output power based on the value related to the output power supplied during the first puff.

According to another aspect, embodiments of the power output circuit allow the maximum output power supplied to the heating element during the subsequent puff to be equal to or greater than the output power supplied to the heating element at corresponding times during the first puff.

According to another aspect, embodiments of the power output circuit limit the maximum output power supplied to the heating element during the subsequent puff to 200% of an average output power supplied to the heating element during the first puff, or less.

According to another aspect, embodiments of the power output circuit limit the maximum output power supplied to the heating element during the subsequent puff to 200% of an instantaneous output power supplied to the heating element during the first puff, or less.

According to another aspect, embodiments of the resistance measuring component determine and store electrical resistances of the portion of the electric path including the heating element at different times during the first puff, and control replaying a resistance trace with multiple resistances by following a sequence of values corresponding to times at which the values were recorded.

According to another aspect, embodiments of the control circuit also include an electric connection for communicating with a user interface or attachment that is to be manipulated to receive a selection of a recorded profile of the first puff.

According to another aspect, if a duration of the subsequent puff is longer than a duration of the first puff, a resistance value based on a value stored in the recorded profile for the first puff is maintained by the control system until the subsequent puff is completed.

The above summary presents a simplified summary in order to provide a basic understanding of some aspects of the systems and/or methods discussed herein. This summary is not an extensive overview of the systems and/or methods discussed herein. It is not intended to identify key/critical elements or to delineate the scope of such systems and/or methods. Its sole purpose is to present some concepts in a simplified form as a prelude to the more detailed description that is presented later.

### BRIEF DESCRIPTION OF SEVERAL VIEWS OF THE DRAWING

The invention may take physical form in certain parts and arrangement of parts, embodiments of which will be described in detail in this specification and illustrated in the accompanying drawings which form a part hereof and wherein:

FIG. 1 schematically shows a partially-cutaway view of an illustrative embodiment of an electronic vaporizer that includes a control system for reproducing a puff based on a stored recorded profile;

FIG. 2 is a block diagram showing an illustrative embodiment of a portion of a control system that records resistance values determined during a puff and generates a recorded profile with the recorded resistance values;

FIG. 3 is a schematic representation of an embodiment of a control system in the form of PID controller that controls replaying a previous puff based on a stored recorded profile that was generated by measuring resistance values at different times during the previous puff;

FIG. 4 shows an illustrative example of resistance behavior when a common output power is supplied without consideration of the resistance values of the heating element during different puffs;

FIG. 5 shows an illustrative example of power curves controlled based on resistance values in the presence and absence of a liquid;

FIG. 6 shows an illustrative example of resistance behavior during a previous puff and a replay of the previous puff during a subsequent puff, where the starting temperature of the heating element at the start of the subsequent puff is lower than at the start of the previous puff;

FIG. 7 shows an illustrative example of resistance behavior during a previous puff and a replay of the previous puff during a subsequent puff, where the starting temperature of the heating element at the start of the subsequent puff is higher than at the start of the previous puff; and

FIG. 8 shows an illustrative example of resistance behavior during a previous puff and a replay of the previous puff during a subsequent puff, where the initial output power supplied at the start of the subsequent puff is approximately 200% of the initial output power supplied at the start of the previous puff.

### DETAILED DESCRIPTION OF THE INVENTION

Certain terminology is used herein for convenience only and is not to be taken as a limitation on the present invention. Relative language used herein is best understood with reference to the drawings, in which like numerals are used to identify like or similar items. Further, in the drawings, certain features may be shown in somewhat schematic form.

It is also to be noted that the phrase “at least one of”, if used herein, followed by a plurality of members herein means one of the members, or a combination of more than one of the members. For example, the phrase “at least one of a first widget and a second widget” means in the present application: the first widget, the second widget, or the first widget and the second widget. Likewise, “at least one of a first widget, a second widget and a third widget” means in the present application: the first widget, the second widget, the third widget, the first widget and the second widget, the first widget and the third widget, the second widget and the third widget, or the first widget and the second widget and the third widget.

The invention described here relates to the control of an electronic vaporizer. An electronic vaporizer controls a heating element to simulate smoking or inhaling a substance (interchangeably referred to herein as an “e-liquid” or a “liquid”). One object of the present technology is to prevent overheating of the e-liquid, and the inhalation of a burnt e-liquid. At ordinary heating element temperatures (typically around 400-480° Fahrenheit), heating causes the e-liquid to boil, and the device user inhales it. This is called “taking a puff”. There are users who activate their electronic vaporizer before they inhale from it, allowing the heating element to warm beforehand. Others deactivate their electronic vaporizer before boiling has ceased while continuing to inhale, so that the device does not contain excess e-liquid afterwards. Because users' behaviors differ, a “puff” should be understood as a continuous period of time where either the e-liquid is boiling, the user is inhaling, or both. A puff, from the standpoint of the electronic vaporizer, can be considered to start when either or both the heating element is generating vapor, or the user is inhaling through the electronic vaporizer. The performance of a puff by the electronic vaporizer concludes when the heating element ceases to generate vapor, and the user ceases to inhale through the electronic vaporizer. As temperatures rise, however, e-liquids thermally decompose into other substances that may have an unpleasant taste, or may otherwise be undesirable. Although described herein as a liquid or e-liquid for convenience, it is to be understood that the substance, referred to herein generically as a medium, can be in the form of a liquid, gel, solid (e.g., tobacco product or powder), viscous liquid, or any other form. The terms liquid and e-liquid are used herein for the sake of brevity and clarity to describe illustrative embodiments of the present technology.

To prevent this, a number of methods to limit the temperature of the heating element have been considered. One is to construct a heating element of a material with a resistance that changes in a known way with temperature, measure the electrical resistance of a heating element at a known temperature (typically room temperature), and limit the temperature using this known relationship. This approach, known as “direct temperature control,” works in theory but has a number of disadvantages in practice.

First, direct temperature control requires the heating element material to be consistent electrically. For pure elemental materials such as Nickel, this is not a problem, but some, such as Stainless Steel, are alloys graded in mass production by their mechanical properties. This means that the electrical relationship of the material varies batch-to-batch and introduces inconsistency in the temperature experienced.

Second, the heating element temperature may not actually be at room temperature when it is first measured, as assumed in direct temperature control, so that the “known temperature” is wrong. If a heating element has been used recently and has just been attached, it may be inside a tank of e-liquid above room temperature. When the electronic vaporizer measures this heating element, it will still be hot, but the electronic vaporizer will be at room temperature, so the electronic vaporizer will believe the heating element to be a higher resistance heating element than it really is. This is encountered when people are swapping heating elements to try at vape shops or tasting events. This erroneous assumption that the heating element is at room temperature is further complicated because electronic vaporizers are not 100% efficient. Due to heat production the local measured “room” temperature around the device may be hotter than the room actually is. Thermal modeling of the electronic vaporizer case can help mitigate this but not solve it entirely, and is another source of error.

Third, there is more in the electrical path of the heating element than just the heating element, itself. The electrical resistance of copper wire varies with temperature, for instance. Between the circuit board and the heating element there is often a static resistance. Many heating elements on the market are detachable, so there is contact resistance. For example, a Stainless Steel heating element has a resistance at 450° Fahrenheit approximately 19% higher than at 70° Fahrenheit. If the heating element has a not atypical room temperature resistance of 200 milliohms, this means the entire change from cold to hot is 38 milliohms of resistance. If copper wires, wire leads, and/or the quality of soldering connecting electric circuit components add even two milliohms of resistance more than expected, the 20% rise will be incorrectly determined to be 470° Fahrenheit.

Fourth, some materials such as Titanium for example, form an oxide or contamination layer at the electrical contacts over time if not used. Once power is applied and the heating coil undergoes a thermal cycle, the brittle oxide layer may crack off due to thermal expansion, or the contamination layer may vaporize This means that a brand-new or not-recently-used heating element may, at room temperature, appear to have a higher resistance than it will in operation. This makes the first use of such a heating element hotter than a static measurement of the system before power is applied would suggest, and if the user adjusts their temperature setting down to compensate, they will find it fine for the current session, but cooler than expected in their next session, when the oxide layer has been lost and the temperature is more-accurately determined.

The above effects have caused some people to consider temperature control to be unreliable or inconsistent. As a result, most devices still use wattage control (as described in U.S. Pat. No. 8,820,330, for example) exclusively. Wattage control involves directly controlling the output power of a heating element to maintain a constant, user-defined output power, without taking into consideration the heating element's resistance as a variable. In other words, under wattage control, the output power supplied to the heating element is directly controlled to a preset wattage level by the device. The assumption underlying power control is that the same output power supplied to the heating element will bring about the same user experience for each puff. However, as explained above, the considerable variations of the heating element's resistance and environmental factors such as the latent heat of the system, ambient temperature or consumable depletion may not allow for accurate reproduction of the previous puff. Alternatively, lower cost devices may control the output voltage, output current, or simply pass battery voltage through to the heating element. In all these cases, the heater resistance, which is a proxy for system temperature, may differ from puff to puff.

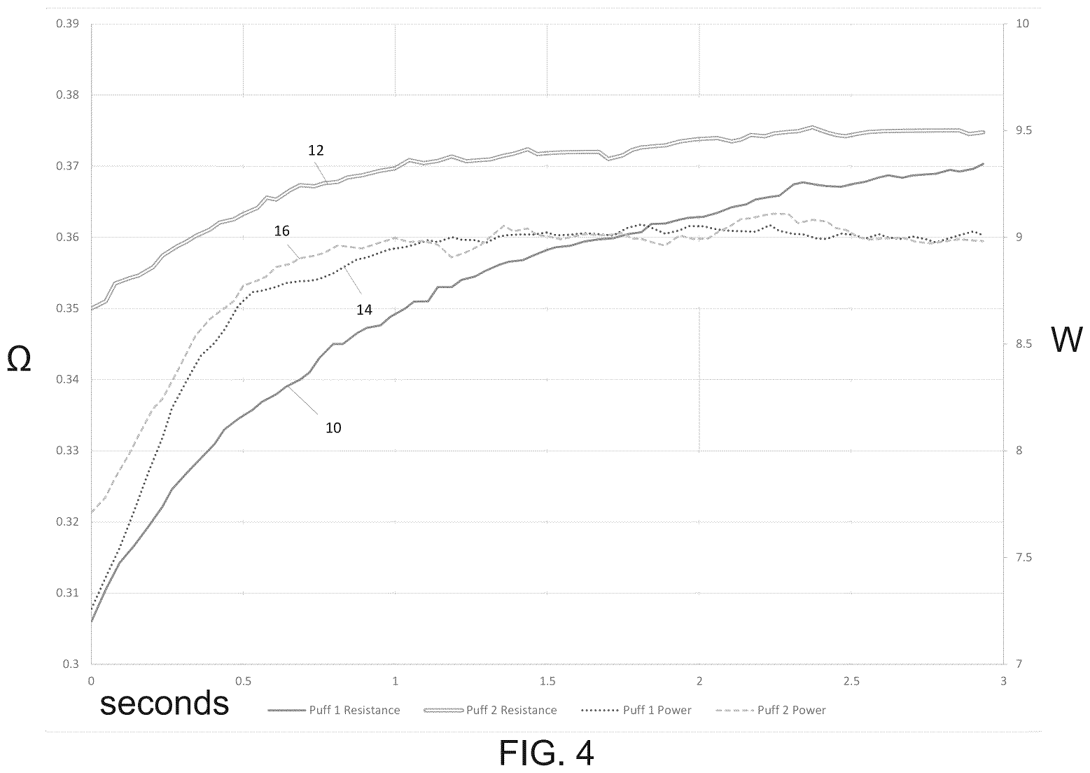

For example, a plot of heating element resistance (Ω) versus time (seconds) during successive puffs according to wattage control is shown in FIG. 4. As shown, curve 10 depicts the resistance of a heating element that is at room temperature at the start of a first puff. Curve 12 depicts the resistance of the same heating element that is at an elevated temperature, above room temperature, at the start of a second puff that is performed after the first puff has been completed. The second puff may have been initiated before the heating element has cooled to room temperature after the first puff. For each puff, 9 W of output power is supplied to the heating element as indicated by the curves 14, 16 for the first and second puffs, respectively. As can be seen from the curves 10, 12, the resistance of the heating element varies significantly during each puff, and the final resistance of 12 is higher than that of 10. This is typical of wattage control and most other non-temperature control methods—closely spaced subsequent puffs are at higher and higher resistance. Because the resistance of the heating element varies with temperature, the user's experience during each puff is significantly different because the temperature profile of the heating element during each puff changes.

The technology described herein represents a significant improvement on the state of the art. It provides the safety of a limited temperature, but by a wholly different approach than direct temperature control and wattage control. This new approach does not suffer from the common problems people experience with those methods. Beyond that, it provides a more consistent flavor profile than has been possible with any previous method.

The present disclosure relies on the user to determine a desirable puff, and then replicates that puff experience on subsequent puffs. Specifically, the electronic vaporizer contains recording components and functionality to generate and store a recorded profile, and operates on heating elements which change their resistance in response to temperature changes. While the user is taking a puff on the electronic vaporizer, a portion of a control system provided to the electronic vaporizer occasionally, or continually, samples and computes, or otherwise determines the resistance of at least the heating element, and optionally the electrical path of the heating element that includes at least one circuit component in addition to the heating element. The determined resistances can be used to generate a trace of the determined resistance values versus time during the puff as part of the recorded profile, as the puff is being experienced. When the user finds a puff they consider pleasant, or expects the next puff to be performed to be pleasant, the pleasant puff referred to generically herein as a “first puff” or a “previous puff,” they can submit a user input via a user interface by pressing a button, or otherwise indicating a desire to save the puff. The received input causes the control system to store the recorded profile of the puff in a non-transitory, computer-readable medium. The non-transitory, computer-readable medium can include a non-volatile memory such as a solid-state hard drive, optical disk ROM, magnetic disk, etc.; a volatile memory such as RAM or a CPU register; any other non-transitory memory device, or any combination thereof.

According to other embodiments, the control system can be configured to automatically record one or a plurality of recorded profiles for the first puff, without manually submission of an instruction via a user interface. For example, the control system can be programmed with computer-executable instructions or otherwise configured to record a second, third, fourth, or subsequent puff following an initial puff, or the first two or more puffs of a vaping session, for example. A vaping session can be considered a time during which a user begins to use an electronic vaporizer to perform at least one puff, and optionally a plurality of puffs before discontinuing use of the electronic vaporizer for a time. The vaping session can optionally be initiated following an extended period (e.g., at least five minutes, or at least 10 minutes, etc.) of nonuse. The electronic vaporizer can optionally be acclimated to its ambient environment (e.g., the heating element at the ambient temperature). Automatic recording of a recorded profile for one or more puffs as described herein is premised on the assumption that the heating element acquires thermal energy during the initial puff, or the initial plurality of puffs during a vaping session, and is at a primed operational temperature during a subsequent puff, such as the third puff, for example. Once primed, the heating element may be operable to produce more consistent puffs than the first one or more puffs performed before the heating element is primed.

To replay or reproduce the previous puff for which the stored recorded profile was generated, the control system can vary an output power supplied to the heating element. Varying the output power or other parameter governing the generation of heat by the heating element can optionally be performed primarily on the determined resistance of the heating element during the replay of the previous puff. According to other embodiments, varying the output power or other parameter governing the generation of heat by the heating element can optionally be performed exclusively on the determined resistance of the heating element during the replay of the previous puff. For example, the output power can be adjusted to cause the resistance values of the heating element to closely approximate, or at least target the determined resistances at corresponding times during the puff corresponding to the stored recorded profile. In other words, replaying the previous puff involves an attempt to cause the heating element to exhibit resistance values at different times during subsequent puffs that match the resistance values at analogous times included in the recorded profile, and cause the resistance trace of the previous puff and the one or more subsequent puffs to be similar, or matching. The targeted resistances will be reproduced, for example, by decreasing the output power to the heating element when a subsequent puff is initiated before the heating element has had a chance to completely return to room temperature or other dormant temperature from an earlier puff, or increasing the output power if the system environment is colder than it was during the stored puff Thus, a different output power can be supplied to the heating element for the previous puff and the subsequent puff, to cause approximately the same recorded profile to be exhibited by the heating element during both puffs.

The present control system and method avoid at least some of the major issues of direct temperature control discussed above by controlling the output power based on the determined operational resistance of the heating element, and optionally the electrical path including the heating element. The operating resistance is determined, so that is a known value. Room temperature is unimportant for the present control systems and methods, so that value can optionally be excluded from consideration in controlling the output power based on the recorded profile. Additional resistance (in addition to the heating element) in the electrical path can be incorporated into the resistance(s) of the recorded profile, thereby eliminating the need to separately account for such values and making the present technology effective despite variances between electronic vaporizers. Further, temporary oxide layers formed on a new heating element will be of minimal concern because the vast majority of recorded profile data that is saved occurs after significant power has been applied and the oxide layers have been lost.

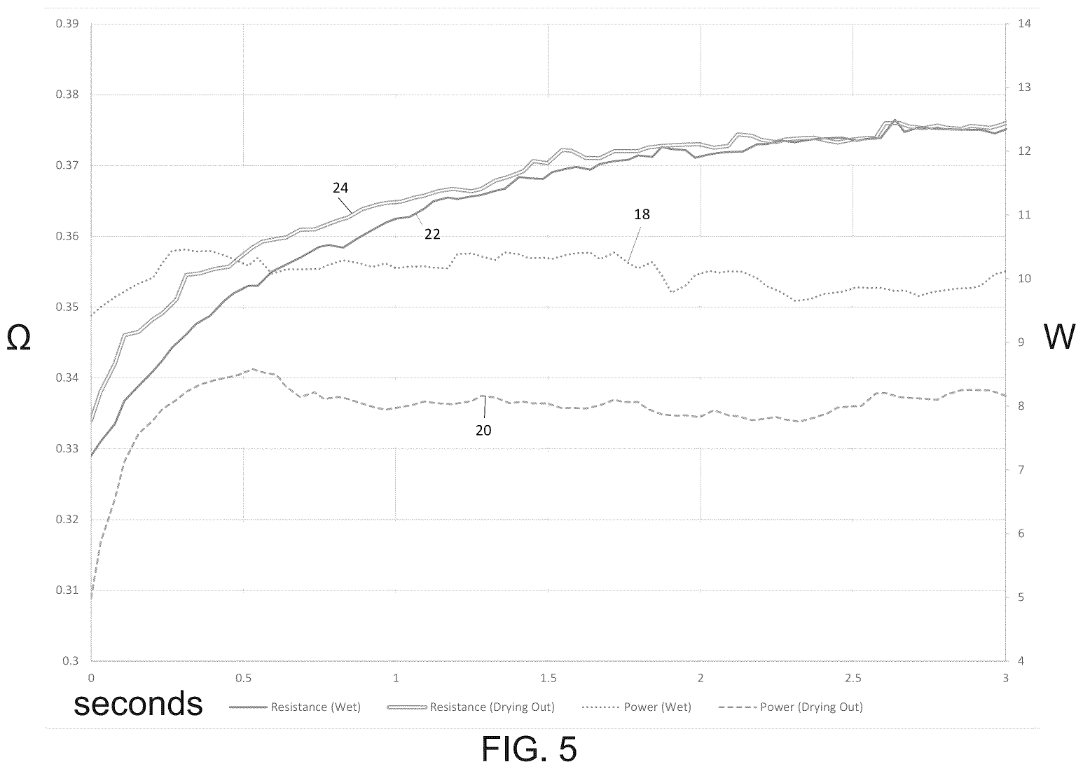

According to the present control systems and methods the actual temperature of the heating element can optionally not be measured or determined, so that value remains an unknown. It is believed that most users who manually select a desired output power, operating temperature, or manually specify another operational parameter of the electronic vaporizer choose these parameters to avoid inhaling the unpleasant burnt e-liquid by feel and personal preference. So, it is assumed for the present disclosure that if a user submits input via the user interface indicating a desire to store the recorded profile for future use, the peak temperature achieved by the heating element during that puff is below a temperature that would cause burning of the e-liquid to be perceptible. As a result, the invention provides the benefit of limiting temperature, but is simple to use—record/play—no technical knowledge or understanding of output power, the resistivity or other qualities of the heating element, etc., is required of the user. Because the recorded profile chosen by the user will not include temperatures that produce unpleasant burnt tastes, if the liquid reservoir starts to dry out, the system will still not allow the resistance (and so, the corresponding temperature) to rise significantly above those in the recorded profile. As a result the output power will automatically be reduced significantly, since the dry condition requires far less power to heat up. This arrangement naturally prevents overheating at low liquid levels. Automatic reduction of the power supplied to the heater element when the reservoir is depleted to maintain the stored recorded profile is shown in FIG. 5.

A power curve 18 is shown in FIG. 5 for a puff for which the recorded profile is recorded in the presence of an ample supply of the liquid. A power curve 20 is also shown for a subsequent puff, when the liquid is in short supply or is drying up. To replay the profile, the control system is operable to cause the resistance traces 22, 24 for the wet puff and the drying puff, respectively, to converge, or closely approximate or follow each other. As a result, the output power supplied to the heating element when the liquid is drying up is substantially less than the output power supplied to the heating element in the presence of an ample amount of the liquid. Thus, overheating of the heating element and/or wicking material can be limited in an attempt to avoid introducing a charred taste to the user.

As for flavor, different flavor molecules boil and are primarily tasted at different temperatures. The majority of e-liquids contain a mixture of several flavor molecules. Wattage control tends to increase the heating element's temperature gradually, which allows for a complex flavor profile. However, when taking multiple puffs back-to-back, the average and peak temperature continues to rise puff-to-puff. As a result, to taste the same flavors as a previous puff, the user must wait to take a new puff until the heating element has cooled to the temperature it was at when the previous puff began. So wattage control lets the user experience pleasant flavor, but not in a way that is accurately repeatable puff-to-puff, particularly if a subsequent puff is commenced before the heating element has sufficiently cooled from a previous puff.

Temperature control, by contrast, tends to taste “muted”, because the vast majority of the puff is at a fixed, instead of changing, temperature. Recording a resistance trace as part of a recorded profile provides a more consistent flavor profile than only wattage control or only temperature control, alone, because the resistance trace will go through all of the recorded temperature ranges. So the temperature of the heating element throughout the puff will vary in a pattern that resembles the pattern of the heating element's temperatures that occurred during the recorded puff, instead of changing puff-to-puff. It is more flavorful than a direct temperature control puff, but also more consistent as it is controlled throughout instead of hitting a temperature limit at some point during the subsequent puff and staying there.

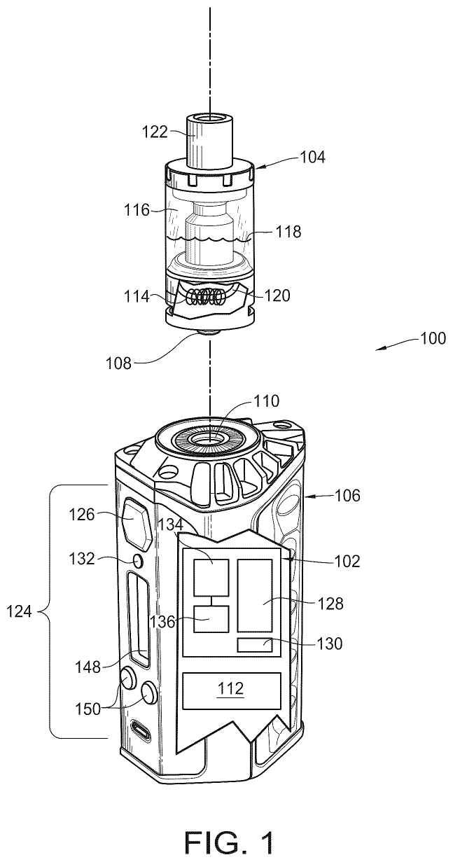

Turning to the drawings, FIG. 1 schematically shows an illustrative embodiment of an electronic vaporizer 100 that includes a control system 102 for reproducing a puff based on a stored recorded profile. The electronic vaporizer 100 is configured to include a tank 104, also referred to as an atomizer, that is releasably coupled to a vaporizer body 106. The tank 104 is removable, and capable of being re-installed on the vaporizer body 106 or replaced by a compatible replacement tank. The tank 104 includes a first connector portion 108 (e.g., a male threaded member in FIG. 1) that cooperates with a second connector portion 110 (e.g., a female threaded receiver in FIG. 1) to install the tank 104 on the vaporizer body 106 in a removable manner, but other releasable/re-installable connectors can be utilized. For example, compatible twist-lock fastener components, or any other releasable connector components can be utilized to allow for the installation of the tank 104 onto the vaporizer body 106 and the removal of the tank 104 from the vaporizer body 106.

The first and second connector portions 108, 110 can collectively form an electrical connector that establishes an electrical connection between the tank 104 and the vaporizer body 106. Output power can be supplied from a battery 112 or other power source provided to the vaporizer body 106 to electric components such as a heating element 114 provided to the tank 104 as described in detail herein. An example of the battery 112 includes, but is not limited to a rechargeable, Lithium-ion battery, for example, but other energy sources are also contemplated by the present disclosure.

The tank includes a reservoir 116 that stores the e-liquid 118. Wicking material 120 is arranged in fluid communication with the e-liquid 118 in the reservoir 116, and positioned adjacent to the heating element 114. The wicking material 120 conveys the e-liquid 118 from the reservoir 116 to the heating element. Activation of the heating element 114 as described herein elevates a temperature of a portion of the e-liquid conveyed by the wicking material 120, converting the portion of the e-liquid 118 into a vapor.

The term “vapor,” as used herein, refers to gaseous molecules of the e-liquid 118 that are evaporated, and small liquid droplets of the e-liquid 118 that are to be suspended or entrained in the air as an aerosol, as a result of being exposed to an elevated temperature of a heating element 114 provided to the tank 104. It is the vapor entrained in the air that is inhaled by a user of the electronic vaporizer through a mouthpiece 122, which is provided to the tank 104 of the illustrative embodiment appearing in FIG. 1.

The embodiment of FIG. 1 shows the tank 104 as being removable from the vaporizer body 106. However, it is to be understood that other embodiments of the electronic vaporizer 100 can include a permanently-installed tank that is formed as an integral component that is fixed to the vaporizer body, and is not removable from the vaporizer body without damaging the electronic vaporizer. Such an electronic vaporizer configuration is commonly referred to as an electronic cigarette. The electrical connection with a heating element that elevates the temperature of the e-liquid for such alternate embodiments can be a hardwired connection that is not to be separated and reconnected without damaging the electronic vaporizer. For the sake of brevity and clarity, however, the present technology will be described with reference to the electronic vaporizer 100 that includes a separable tank 104 as shown in FIG. 1.

A user interface 124 is provided to the vaporizer body 106, and includes selectable input devices that offer the user an ability to input commands and optionally user-defined settings that control at least one, and optionally a plurality of parameters of the electronic vaporizer 100. Examples of such parameters include at least one of: a user-specified power setting for the heating element 114; a desired vapor temperature setting; and a quantity setting that defines at least one of: a quantity of a chemical constituent desired to be included in the vapor, and a gas fraction of the chemical constituent in the vapor.

The user interface 124 includes a fire button 126 that, when pressed, causes the control system 102 to initiate a puff and/or replay a previous puff by controlling the supply of output power to the heating element 114 as described herein. The heating element 114 is energized by the output power to generate the vapor for the puff. According to alternate embodiments, the fire button 126 can be replaced by a control routine programmed into a computer processor 128, such as a microcontroller for example, of the control system 102. The control routine can optionally include computer-executable instructions stored in a non-transitory, computer-readable medium 130. When executed, the instructions of the control routine can automatically activate the heating element 114 in response to detecting a negative pressure or the flow of air through the tank 104 caused by the user inhaling through the mouthpiece 122. Regardless of how a puff is activated, output power is to be supplied by the battery 112 to the heating element 114 under the control of the control system 102 to “replay” or “reproduce” or “repeat” a previous puff as described herein.

The user interface 124 can also include a record/playback button 132, or other suitable data entry device such as a touch-sensitive display, tactile switch, etc. When pressed or otherwise selected before, during or after a puff (referred to herein as a “previous puff” because the previous puff is to be replayed as a “subsequent puff”) to input a save command, the computer processor 128 of the control system 102 initiates a recording mode, described in detail below. Alternatively, the user interface could place the device into a mode where a future puff will be recorded rather than selecting an existing puff. For example, the user can push the record/playback button 132 to trigger recording of the recorded profile for the very next puff, or a later puff to be performed in the future. It is to be understood that “previous puff” does not necessarily require the puff immediately preceding selection of the record/playback button 132 to be recorded. “Previous puff” is used herein for convenience to identify a puff that has been performed that the user desires to replay as a “subsequent puff,” which occurs later in time than the previous puff.

To determine the resistance of a portion of an electric path including the heating element 114, the embodiment of the control system 102 of FIG. 1 also includes a resistance sensing component 134, interchangeably referred to herein as a resistance circuit 134. The resistance sensing component 134 is electrically connected to the heating element 114, and optionally other conductive components included in the electrical path between the battery 112 and the heating element 114. The resistance sensing component 134 can include at least one of a current sensor, a voltage sensor and/or a divider to measure an electric current through, and/or a voltage across the heating element and/or other portion of the electric path that includes the heating element. Based on the measurements, the resistance sensing component 134 can calculate or otherwise determine the resistance of the portion of the electric path electrically connected to the current and/or voltage sensor(s).

For example, the resistance sensing component 134 can be coupled to the electrical connector formed through cooperation between the first and second connector portions 108, 110 that couple the tank 104 to the vaporizer body 106. According to such an embodiment, the resistance sensing component 134 can determine the resistance of the portion of an electric path including the electric connection, the heating element 114, and the other circuit components in the portion of the circuit formed provided to the tank 104.

The embodiment of the control system 102 shown in FIG. 1 also includes a power output component 136. Examples of the power output component 136 can include a DC-DC converter such as a buck and/or boost converter, or other suitable circuit to adjust the power supplied by the battery 112. The power output component 136 is controlled by a pulse-width modulation signal transmitted by the computer processor 128 to step up and/or step down the voltage supplied by the battery 112 to produce the output power. According to other embodiments, the electric current and/or the voltage supplied by the battery 112 can be controlled by the power output component 136 in real time while a previous puff is being replayed. The output power is controlled to supply the heating element 114 with a suitable output power to cause the heating element 114 (and optionally other portion of the electric path) to exhibit a resistance trace similar to that of a stored recorded profile. The stored recorded profile can optionally also include values of the output power supplied to the heating element during the previous puff to cause the heating element 114 to exhibit, during the subsequent puff, the same or similar electrical resistance values. The stored recorded profile can optionally also include values of the output power supplied to the heating element 114 during the previous puff to cause the heating element 114 to exhibit, during the subsequent puff, the same or similar changes to the electrical resistance that was exhibited during the first puff.

The resistance values in the recorded profile can be used by the computer processor 128 to determine a range. For example, a range might be determined by finding (or loading, if they have been stored beforehand) the minimum and maximum resistance values in the recorded profile and computing the difference between them. This range can optionally be utilized by the computer processor 128 to establish a reactivity of the control system 102. The reactivity of the control system 102 is indicative of the rate at which incremental corrections are made based on the error between a sensed resistance value during the subsequent puff, from the target resistance value at the respective time in the stored recorded profile. When replaying a puff, there may be limited knowledge about the heating element's thermodynamics. When establishing a reactivity for the control system, one approach is to ensure that the reactivity of the control system declines with increasing range. For example, if the range of resistance values in the stored recorded profile is 0.25 ohms, then the reactivity of the control system 102 should be less than if the range is 0.50 ohms. An error of, say, 0.05 ohms is likely to correspond to a much smaller temperature swing if the range is 0.50 ohms than if the range is 0.25 ohms. This makes the control system respond in a more consistent way to different heating elements than using a fixed reactivity.

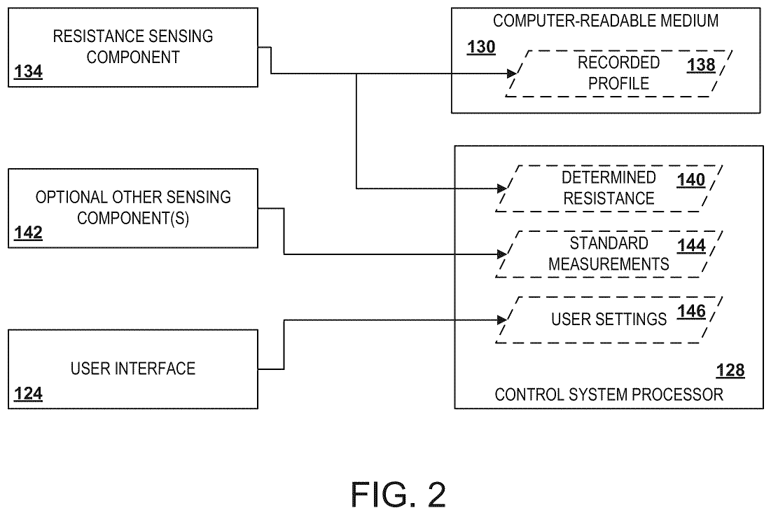

FIG. 2 is a block diagram showing an illustrative embodiment of a portion of a control system 102 that records resistance values determined during a puff, and generates a recorded profile 138 that includes the recorded resistance values. As shown, the resistance sensing component 134 measures or otherwise determines the resistance values occasionally, periodically, or continuously throughout the duration of a puff. The recorded profile 138, which includes the determined resistance values 140 and the times at which the respective resistance values were determined during the puff is generated and stored in the computer-readable medium 130. The determined resistance values 140 are also fed back to the computer processor 128 of the control system 102, and can optionally be utilized in the standard mode to adjust the amount of power supplied to the heating element 114.

Optional other sensing components 142 such as a power sensor for example, or another sensor can optionally be provided to monitor operation of the heating element 114 during a puff and supply the optional data 144 in the standard mode. User settings 146 submitted through user input into the user interface 124 can be provided to the computer processor 128 of the control system 102 as references. The user settings 146 establish operational thresholds and limits to which the measured resistance values 140, any optional data 144, and/or values derived therefrom, can be compared to adjust the output power supplied to the heating element 114 by the control system 102. The comparison results allow the computer processor 128 of the control system 102 to adjust the pulse-width modulated signal transmitted to the power output component 136 to control the supply of the output power to the heating element 114.

As a more specific example, when the fire button 126 is pressed and the electronic vaporizer 100 is not replaying a previous puff, the control system 102 operates on other parameters. For example, a user may set a desired power level via the user interface 124, which is included in the user settings 146. The duty cycle of the pulse-width modulation signal is adjusted to move the measured power—the product of the current and voltage sensors (Power=Current X Voltage)—towards the desired power level.

The present example can also control the output power to limit the battery voltage drop, maximum battery and output currents, maximum output voltage, as well as other parameters, some user-configurable, which can be monitored by appropriate sensors and fed back to the computer processor 128 as the standard measurements 144. While the electronic vaporizer 100 is controlling in this manner, and not replaying a stored recorded profile from a previous puff, the control system 102 is recording the resistance trace (Resistance=Voltage/Current, versus time), and storing the resistance trace in the computer-readable medium 130 as shown in FIG. 2. The control system 102 can optionally use a relatively-high sampling rate early during the puff, and a relatively-low sampling rate, that is less than the relatively-high sampling rate, later in the puff (e.g., towards the end), to capture the initial resistance rise accurately while conserving storage space in the computer-readable medium 130 for the rest of the puff. Other methods of compression could also be used, such as reducing the resistance recording to a constant, polynomial, or other mathematical curve.

Due to Ohm's Law (Voltage=Current X Resistance), the recording of resistance could be implemented by recording voltage with a known current, current with a known voltage, or some other permutation, but such values are proxies for resistance. According to alternate embodiments, approaches to measuring resistance other than measuring voltage and/or current could also be utilized without departing from the scope of the present application. For example, a resistor divider with a known resistance can be put in-circuit to measure the heating element's resistance during a puff.

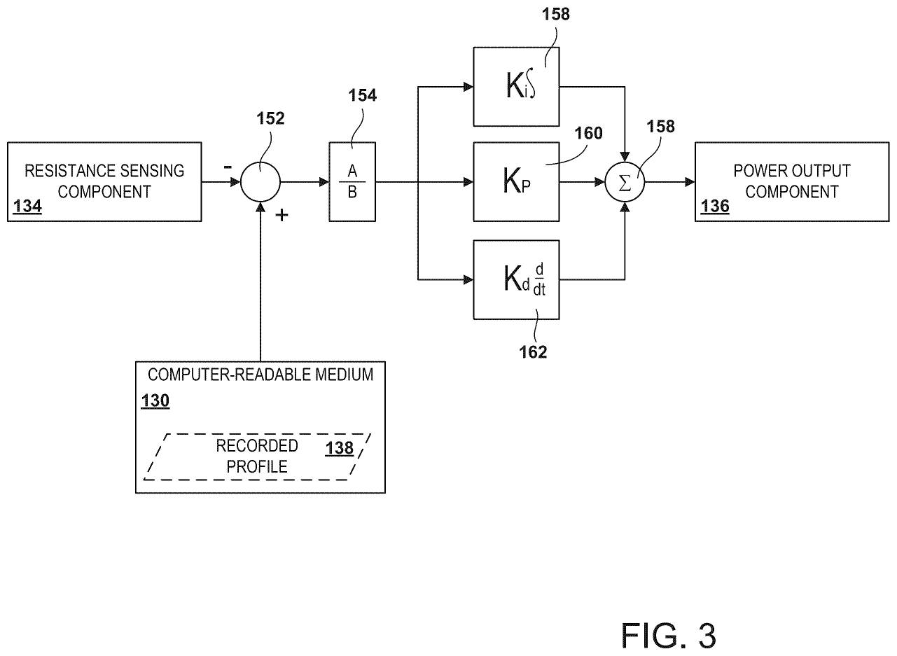

When the user “locks” the resistance by pressing the record/playback toggle, the electronic vaporizer 100 goes into resistance playback mode and an indicator is activated to indicate that the electronic vaporizer 100 is operating in the playback mode. FIG. 3 is a schematic representation of a portion of the control system 102 in the form of PID controller, that controls replaying a previous puff based on a recorded profile 138 that was generated by measuring resistance values 140 at different times during the previous puff.

For example, an LED can be illuminated, a notification can be displayed by an LCD display 148 (FIG. 1), etc. When the fire button 126 is pressed and the electronic vaporizer 100 is replaying a recorded profile 138, the control system 102 can adjust the duty cycle of the pulse-width modulation signal, for example, to move the resistance measured by the resistance sensing component 134 during the subsequent puff—the quotient of the voltage and current sensors (Resistance=Voltage/Current)—towards the recorded resistance in the recorded profile. The present embodiment can optionally continue to limit other parameters such as a desired power level input via the user interface 124, which is included in the user settings 146 (FIG. 2). “Locking” the resistance could be done with an on-screen button, toggle, or any other suitable user interface element. Simply pressing the record/playback button 132, for example, could replay the most-recently stored recorded profile.

In other embodiments, the method of selecting a stored recorded profile of a puff to play back could be more complex. For example, the electronic vaporizer 100 could allow the user to scroll through previous puffs, displayed via the LCD display 148 (FIG. 1), and choose the puff they would like to play back. The electronic vaporizer can optionally include “back” and “forward” buttons 150 (FIG. 1) that could be pressed multiple times to cycle through stored recorded profiles, each with a user-specified name, time stamp, or other identifier, before “locking” (selecting) a desired puff by selecting the record/playback button 132. Another simple approach can allow a user to cycle through stored recorded profiles by repeatedly pressing the record/playback button 132, before pressing another button (e.g., fire button 126) to play back the currently-selected puff. Such an embodiment simplifies the user interface 124, allowing selection of different recorded profiles corresponding to saved puffs with a single button.

According to some embodiments, the output power supplied to the heating element 114 while playing back a stored recorded profile 138 can be limited, to cause a gradual and substantially-uniform elevation of the heating element's temperature along the length or depth of the heating element 114. An excessively-high output power level, applied abruptly, can cause the heating element 114 to develop temperature gradients along its length or radially, with different portions of the heating element 114 being at different temperatures. Many factors will contribute to different temperatures being established at different regions of the heating element 114. For example, some portions of the heating element 114 may be in contact with the wicking material 120, while other portions are not. Thermal energy dissipated from the heating element 114 to the wicking material 120 through conduction may cause the portion of the heating element 114 in contact with the wicking material 120 to be cooler than a portion of the heating element 114 that is not in contact with the wicking material 120, which dissipates thermal energy through convection. A localized hot spot can develop at the portion of the heating element 114 that is not in contact with the wicking material 120. Contact with the wicking material 120 is merely one example of the factors that can contribute to the formation of temperature gradients along the length of the heating element 114. Since it is believed that the measured overall resistance has some (largely monotonic) relationship to the spatial average temperature of the heating element 114, the reliability of the user experience is enhanced if the average temperature along the length of the heating element 114 is relatively close to the minimum and maximum temperatures established along the length of the heating element 114. A large maximum input power can cause localized heating of portions of the system faster than the thermal conductivity of the system can bring the various components into thermal equilibrium, causing large transients with localized hot areas. Because only the average resistance of the heater system is recorded and played back, an overly hot section will create bad tastes or other adverse effects that the controller can't correct via the resistance control system. For example, the rate of change of the temperature of the heating element 114 can be limited by limiting the maximum output power to be a value that causes all portions along the length of the heating element 114 to be within perhaps 20% of the average temperature of the heating element 114 during an individual puff at all times during the puff.

According to alternate embodiments, the power limit applied can be functionally related to the power applied during the recorded puff. By applying unlimited power, it is believed to be possible to match the recorded profile of the previous puff. Because resistance measurements are averages over the entire heating element surface, however, matching the resistance too aggressively may result in an under-prediction of the peak temperature, introducing locations of burnt flavor. It would also “force” a flavor, ignoring the user's expectation for a particular air flow rate. Making the power limit related to the original puff power promotes a forcefulness of playback reminiscent of the original puff and limits the maximum air flow, improving the perceived experience.

As a user takes more puffs over a session, and the heating element 114 continues to elevate in temperature, it is intuitive to conclude that the output power required to maintain the rising temperature of the heating element 114 would decline. Although true for puffs in rapid succession, the playback output power limit can be equal to, or preferably greater than, the original puff power. This allows the electronic vaporizer 100 to “play catch up” (i.e., to exhibit a similar recorded profile as that of the previous puff, or achieve a similar peak temperature as the previous puff) to the targeted resistance if the heating element 114 has cooled, or if the user has inhaled more-strongly than during the original puff.

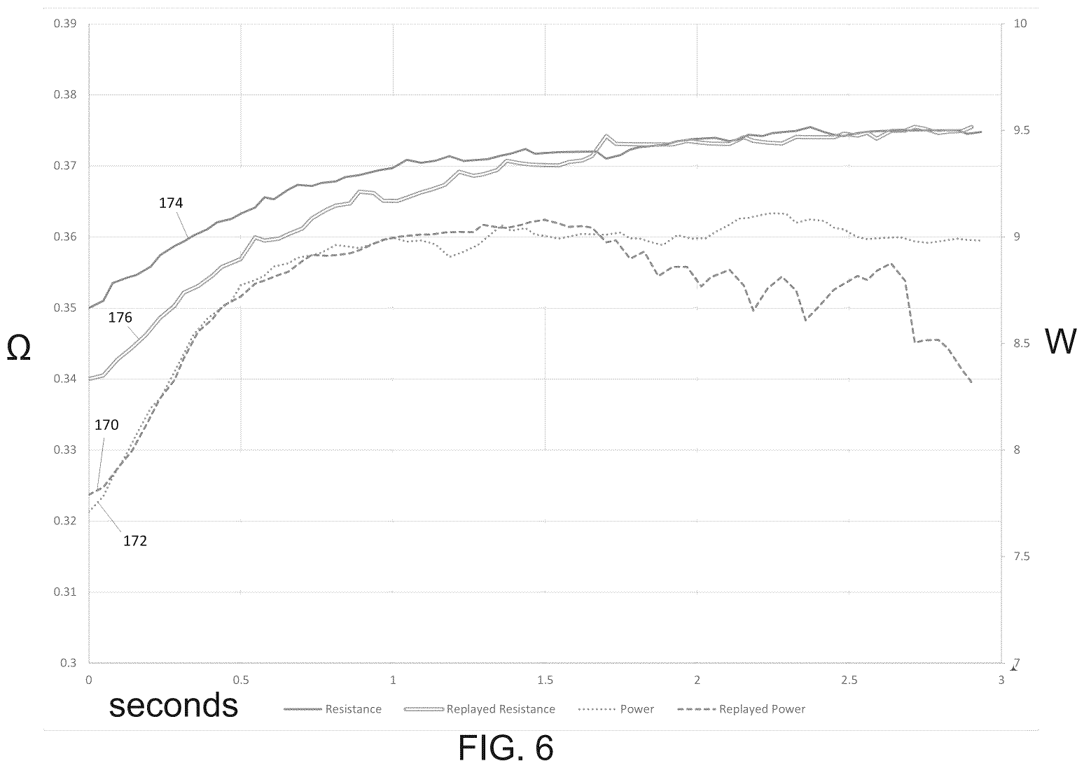

FIG. 6 shows an illustrative result of playing back a recorded profile based on a previous puff, where the output power supplied to the heating element 114 is not allowed to be greater than the previous puff power (9 watts), and the temperature and hence the resistance of the heating element 114 at the start of the subsequent puff is lower than the temperature and hence the resistance of the heating element 114 at the start of the previous puff.

Because the output power is controlled by the power output component 136 during the subsequent puff to not exceed the previous puff power, the curve 176 representing the sensed resistance of the heating element 114 during the subsequent puff takes 1.5 to 2 seconds to heat up enough to approach the curve 174 representing the sensed resistance of the heating element 114 in the recorded profile 138. In FIG. 6, once the curve 176 has converged onto the curve 174, the power 170 begins to falls off slightly as the heating element dries out a bit.

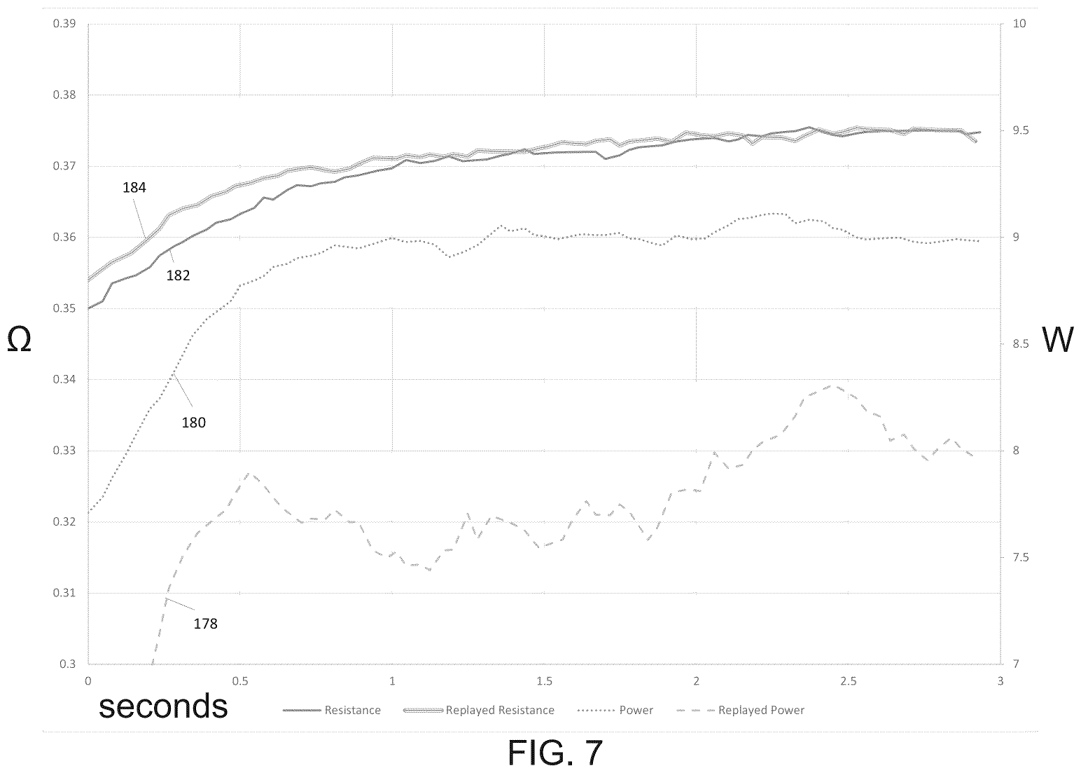

For embodiments where the heating element 114 is warmer at the beginning of the subsequent puff than it was at the beginning of the previous puff, a lower output power can be supplied to allow the subsequent puff's resistance to approach that of the previous puff. For example, as shown in FIG. 7, the curve 178 representing the power supplied to the heating element during the subsequent puff indicates that less than 7 watts of power was supplied at the start of the subsequent puff, and throughout, the heating element 114 is already very hot and never needs the previous puff's 9 watts shown on curve 180 to target the previous puff's resistance 182. Convergence of the resistance curves 182, 184 for the previous and subsequent puffs, respectively, occurs between 1.0 and 1.5 seconds after the puffs began.

For a heating element 114 of unknown composition, a conservative choice is to limit the output power level to the original puff power. In doing so the heating element does not receive more power during the subsequent puff than the user has explicitly asked for. However, more than one puff may be required to allow the playback of the stored recorded profile to get back to the thermodynamic state of previous puff being replayed. Until such an additional puff is performed, the electronic vaporizer 100 may “follow” the recording but not reach it (i.e., have a similar trace shape, but not be equal in magnitude).

According to some embodiments, the maximum output power to be allowed by the control system 102 for targeting the recorded resistance can be limited to no more than 200%, or no more than 150% of the average output power for the previous puff recorded in the recorded profile. In alternate embodiments, the maximum output power can be limited in a way functionally related to instantaneous recorded power, such as 200%, or 150% of instantaneous recorded output power supplied during the previous puff. This could be useful for accurately targeting the resistance, if the previous puff had a time-dependent behavior, such as preheating the heating element 114 to operating temperature with extra power early during the previous puff. For a simple electronic vaporizer without pre-heat ability, for example, this is unnecessary.

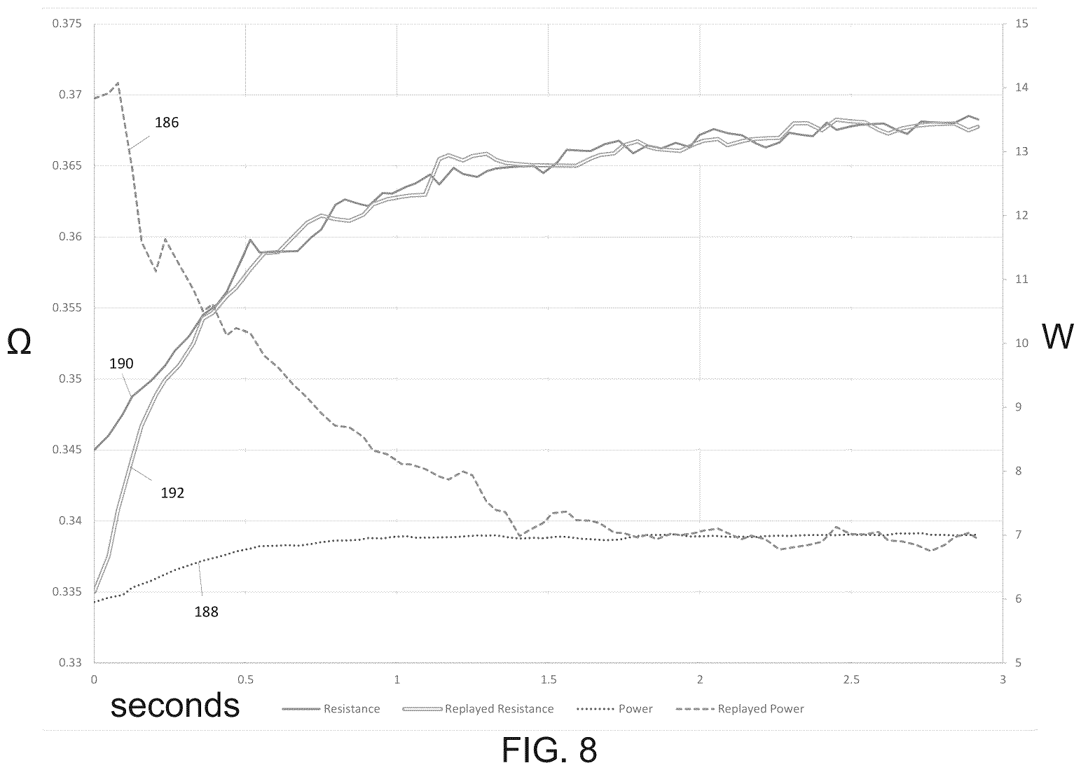

As noted above with reference to FIG. 6, the resistance curves 174, 176 for the previous and subsequent puffs, respectively, cross between 1.5 and 2.0 seconds from the beginning of the puffs. This rate of convergence can be increased by increasing the output power supplied to the heating element 114 at the beginning of the subsequent puff as illustrated in FIG. 8. As shown, the curve 186 representing the output power supplied to the heating element 114 during the subsequent puff indicates that the initial power (˜14 W) was approximately 200% of the output power (˜7 W) that was supplied at the start of the previous puff. The curves 190, 192 representing the resistance values of the heating element 114 during the previous and subsequent puffs, respectively, converge in less than 0.5 seconds.

Referring once again to FIG. 3, regulating the output power supplied to move the heating element's resistance during a subsequent puff toward the recorded resistance values in the recorded profile for a previous puff being replayed is achieved by determining a resistance error. The difference between the recorded resistance values in the recorded profile 138 and the resistance values measured by the resistance sensing component 134 at corresponding times is determined by the differentiator 152.

The difference is then normalized at block 154. For example, the difference between the recorded and measured resistance values can be divided by the difference between the maximum and minimum recorded resistances for normalization purposes. Other embodiments can omit the intermediate step of normalizing the resistance differences into a ratio. However, such a normalization process allows the control system reaction to be tuned to achieve typical and desired thermodynamics independent of the actual resistance of the portion of the electric path including the heating element 114. This is because the maximum resistance is likely to correspond to a desirable vaping temperature, inferred from the user's desire to save the recorded profile for the previous puff, and the minimum resistance is likely to be close to room temperature. The maximum and minimum resistances can optionally also be included in the recorded profile 138.

Once the error has been computed, a target power level is established based on a summation 156 of: a proportion term 158, having a value proportional to the error; an integral term 160, including an integral of the error over time; and a derivative term 162, the value of which is determined based on the derivative of the error. Other parameters can optionally also be combined with the proportional, integral and derivative terms as correction factors at the summation 158.

Although the examples to this point utilize a power output component 136 that is described as adjusting or otherwise controlling the electric power supplied to the heating element in terms of watts, this is implementational rather than a requirement. Any topology that can adjust the power delivered to the heating element 114 could be used with this method. For example, a device might use a voltage-mode DC-DC converter, in which case the output from the resistance control system would be in volts, or the device might use a current-mode DC-DC converter. An even simpler, lower cost product might use hysteretic or bang-bang control, applying full battery power to the heater until the target resistance is reached, and then turning off until a preset time has elapsed or the coil has cooled enough to have the resistance lower than a hysteresis band. In these cases, rather than directly limiting the output power to cause the recorded profile of a subsequent puff to approach that of a previous puff associated with a stored recorded profile, the output voltage or current or duty cycle or on time would be limited. The net effect is equivalent.

Occasionally, a user may cause the subsequent puff to last longer than the entire duration of the previous puff for which the recorded profile was recorded. According to some embodiments, the final recorded resistance sample in the recorded profile can be used as the target for the remainder of the subsequent puff that extends beyond the end of the previous puff. According to other embodiments, the subsequent puff could be terminated by the control system 102. According to yet other embodiments, a resistance value based on any one or more values stored in the recorded profile for the first puff can be used and/or maintained by the control system until the longer subsequent puff is completed.

According to yet another embodiment, the control system 102 can switch to a “continue” mode, in which the control system 102 allows the subsequent puff to continue beyond the duration of the previous puff, but the extended period of the subsequent puff is not controlled based on the recorded profile of the previous puff. Instead, the control system 102 can revert to the standard mode of operation, in which user-defined parameters and/or other monitored parameters can be utilized to control the output power to the heating element 114. This would allow the user to extend their favorite puff and optionally create a new recording by again pressing the record/playback button 132 following completion of the new, extended puff.

In some embodiments, one or more of the components described herein can be configured as including program modules stored in a non-transitory computer readable medium, and/or electronic hardware to perform the functions described herein. Components can be implemented with computer or electrical hardware, a non-transitory medium with stored instructions of an executable application or program module, and/or combinations of these to perform any of the functions or actions as disclosed herein, and/or to cause a function or action from another logic, method, and/or system to be performed as disclosed herein.

Illustrative embodiments have been described, hereinabove. It will be apparent to those skilled in the art that the above devices and methods may incorporate changes and modifications without departing from the general scope of this invention. It is intended to include all such modifications and alterations within the scope of the present invention. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. An electronic vaporizer for elevating a temperature of a heating element having an electrical resistance that changes with changes in temperature, the electronic vaporizer comprising:
a control system that supplies an output power to the heating element to elevate a temperature of a medium to be aerosolized, and convert a portion of the medium into a vapor to be inhaled by a user;
an electrical connector that establishes a conductive pathway between the heating element and the control system;
a resistance measuring component included as part of the control system that determines the electrical resistance of the heating element at one or more times during a first puff and generates a recorded profile for the first puff, the recorded profile comprising data indicative of the electrical resistance of the heating element system during the first puff;
a non-transitory computer-readable medium that stores the recorded profile for the first puff; and
an output control component that accesses the recorded profile and adjusts the output power supplied to the heating element during a subsequent puff based, at least in part, on the recorded profile, to cause the electrical resistance of the heating element during the subsequent puff to approach the electrical resistance of the heating element during the first puff.

2. The electronic vaporizer of claim 1, wherein the recorded profile is stored by the non-transitory computer-readable medium in response to entry of a save command a user interface.

3. The electronic vaporizer of claim 1 further comprising:
a tank comprising the heating element in thermal communication with a wicking material, wherein the tank comprises a portion of a releasable connector that cooperates with the electrical connector to establish the conductive pathway between the heating element and the control system.

4. The electronic vaporizer of claim 3, wherein the output control component controls the output power to cause the heating element to exhibit resistances during the subsequent puff at times when the heating element exhibited similar resistances during the first puff, to mimic operation of the heating element during the first puff from a resistance standpoint.

5. The electronic vaporizer of claim 1, wherein the recorded profile for the first puff further comprises a value related to the output power supplied to the heating element during the first puff.

6. The electronic vaporizer of claim 5, wherein the control system limits the maximum output power supplied to the heating element to a level that is functionally dependent on the power level for the first puff stored in the recorded profile.

7. The electronic vaporizer of claim 5, wherein the control system limits the maximum output power supplied to the heating element to a power level that is equal to or greater than the power level stored in the recorded profile.

8. The electronic vaporizer of claim 7, wherein the maximum power level of the output power supplied to the heating element during the subsequent puff is limited by the control system to no greater than 200% of an average recorded power level of the output power supplied to the heating element during the first puff.

9. The electronic vaporizer of claim 7, wherein the maximum power level of the output power supplied to the heating element during the subsequent puff is limited by the control system to no greater than 200% of an instantaneous power level of the output power supplied to the heating element during the first puff.

10. The electronic vaporizer of claim 1, wherein:
the resistance measurement component determines the electrical resistance of the heating element and generates the recorded profile for a plurality of puffs, and
the control system is operatively connected to a user interface that comprises an input device that, in response to being manipulated following select puffs included among the plurality of puffs that the user desires to replay, causes a recorded profile for the select puffs to be generated and stored in the non-transitory computer-readable medium.

11. The electronic vaporizer of claim 1, wherein if a duration of the subsequent puff is longer than a duration of the first puff, a resistance value based on a value stored in the recorded profile for the first puff is maintained by the control system until the subsequent puff is completed.

12. The electronic vaporizer of claim 1, wherein the control system's reactivity to a resistance change or error decreases with an increase to the range of resistances included in the recorded profile.

13. The electronic vaporizer of claim 1 further comprising a tank that is fixedly installed as part of the vaporizer, and the heating element is hardwired with a fixed connection to the electrical connector.

14. The electronic vaporizer of claim 1, wherein the electrical resistance determined by the resistance measuring component comprises a resistance contribution by the heating element, and a resistance contribution by an electrical path utilized to supply the output power to the heating element.

15. The electronic vaporizer of claim 1, wherein the resistance measuring component determines the electrical resistance of the heating element independently of an actual, measured temperature of the heating element.

16. The electronic vaporizer of claim 1, wherein the output control component adjusts the output power supplied to the heating element during the subsequent puff by, one or more of: adjusting a pulse-width of a voltage of the output power, or using DC-DC conversion.

17. The electronic vaporizer of claim 1, wherein the control system is configured to automatically generate, store and replay the recorded profile without receiving a manually-input instruction from the user.

18. A control circuit for an electronic vaporizer, wherein the control circuit adjusts an output power supplied to a heating element in thermal communication with a media to be aerosolized, to elevate a temperature of the media and convert a portion of the media into a vapor to be inhaled by a user during a first puff, the control circuit comprising:
a resistance measurement circuit that determines electrical a resistance of a portion of an electric path including the heating element at different times during the first puff and generates a recorded profile for the first puff, the recorded profile comprising the determined electrical resistances for the first puff and/or changes of the electrical resistance that occurred at the different times during the first puff;
a non-transitory computer-readable medium that stores the recorded profile for the first puff; and
a power output circuit that accesses the recorded profile and adjusts the output power supplied to the heating element to cause the resistance of the heating element during a subsequent puff to follow or target the recorded profile for the first puff.

19. The control circuit of claim 18, wherein the recorded profile includes a value related to the output power supplied to the heating element during the first puff.

20. The control circuit of claim 19, wherein the power output circuit limits the maximum output power based on the value related to the output power supplied during the first puff.

21. The control circuit of claim 19, wherein the power output circuit allows the maximum output power supplied to the heating element during the subsequent puff to be equal to or greater than the output power supplied to the heating element at corresponding times during the first puff.

22. The control circuit of claim 19, wherein the power output circuit limits the maximum output power supplied to the heating element during the subsequent puff to 200% of an average output power supplied to the heating element during the first puff, or less.

23. The control circuit of claim 19, wherein the power output circuit limits the maximum output power supplied to the heating element during the subsequent puff to 200% of an instantaneous output power supplied to the heating element during the first puff, or less.

24. The control circuit of claim 18, wherein the resistance measuring component determines and stores electrical resistances of the portion of the electric path including the heating element at different times during the first puff and controls replaying a resistance trace with multiple resistances by following a sequence of values corresponding to times at which the values were recorded.

25. The control circuit of claim 18 further comprising:
an electric connection for communicating with a user interface or attachment that is to be manipulated to receive a selection of a recorded profile of the first puff.

26. The control circuit of claim 18, wherein if a duration of the subsequent puff is longer than a duration of the first puff, a resistance value based on a value stored in the recorded profile for the first puff is maintained by the control system until the subsequent puff is completed.
